(19) United States
(12) Patent Application Publication
(10) Pub. No.: US 2014/0147758 A1
(43) Pub. Date: May 29, 2014

(54) FUEL CELL SYSTEM

(71) Applicant: PANASONIC CORPORATION, Osaka (JP)

(72) Inventors: Takashi Akiyama, Osaka (JP); Masaki Mitsui, Kyoto (JP); Isamu Kawata, Osaka (JP)

(73) Assignee: PANASONIC CORPORATION, Osaka (JP)

(21) Appl. No.: 13/982,737

(22) PCT Filed: Oct. 4, 2012
(86) PCT No.: PCT/JP2012/006394

§ 371 Date: Jul. 30, 2013

(30) Foreign Application Priority Data
Nov. 30, 2011 (JP) 2011-261403

(51) Int. Cl. H01M 8/06

(52) U.S. Cl. CPC H01M 8/0662
USPC 429/410

(57) ABSTRACT

Disclosed is a fuel cell system that is capable of improved power generating performance and reduced size, and furthermore, is very safe. The system includes a membrane electrode assembly (MEA), a fuel tank, a liquid collecting tank, a two-liquid-joining unit, a first fuel supply unit, a second fuel supply unit, and a fuel filter. The fuel tank stores a liquid fuel. The liquid collecting tank stores a liquid discharged from at least one of an anode or a cathode in the MEA, as a collected liquid. The two-liquid-joining unit prepares a diluted fuel by mixing the liquid fuel and the collected liquid. The first fuel supply unit supplies the liquid fuel to the two-liquid-joining unit. The second fuel supply unit supplies the diluted fuel to the anode. The fuel filter, disposed between the two-liquid-joining unit and the anode, removes impurities in the diluted fuel.

### TECHNICAL FIELD

The present invention relates to a fuel cell system; and particularly relates to a technique of supplying a liquid fuel and a technique of removing impurities in a liquid fuel.

### BACKGROUND ART

Fuel cells are classified into the following, according to the kind of electrolyte used: polymer electrolyte fuel cells (PEFCs), phosphoric acid fuel cells (PAFCs), alkaline fuel cells (AFCs), molten carbonate fuel cells (MCFCs), solid oxide fuel cells (SOFCs), etc. PEFCs, in particular, are low in operating temperature and high in output density. Thus, PEFCs are gradually being put into practical use as large-scale power sources, such as for automobiles, home congeneration systems, etc.

Recently, studies are being conducted on using fuel cells, in place of rechargeable batteries, as the power source for small mobile electronic devices such as laptop computers, cellular phones, and personal digital assistants (PDAs). Fuel cells can generate power continuously by being refueled. Therefore, fuel cells are not required to be charged, whereas rechargeable batteries are required to be charged. Thus, by being used as the power source for small mobile electronic devices, fuel cells are expected to improve the convenience of such devices. PEFCs, in particular, are low in operating temperature as mentioned in the foregoing, and are therefore preferred as the power source for small mobile electronic devices. Moreover, studies are also being conducted on using fuel cells as the power source for outdoor recreation and backup power.

Among PEFCs, direct oxidation fuel cells (DOFCs), in particular, generate electrical energy by directly oxidizing liquid fuel at room temperature. That is, in DOFCs, it is not necessary to reform liquid fuel into hydrogen. Thus, DOFCs do not require a reformer, and therefore, can easily be reduced in size. Moreover, among DOFCs, direct methanol fuel cells (DMFCs), in particular, which use methanol as fuel, are better in energy efficiency and output power when compared to other DOFCs. Therefore, DMFCs are seen as most promising as the power source for small mobile electronic devices.

Reactions that occur at the anode and cathode in a DMFC are expressed by the following reaction formulae (1) and (2), respectively. A cathode typically takes in oxygen from air.

Anode: CH₃OH+H₂O→CO₂+6H⁺+6e⁻ (1)

Cathode: ( 3/2)O₂+6H⁺+6e⁻→3H₂O (2)

Thus, in a fuel cell, a reaction expressed by the following reaction formula (3) occurs based on the reaction formulae (1) and (2).

Fuel cell: CH₃OH+( 3/2)O₂→CO₂+2H₂O (3)

A polymer electrolyte fuel cell (PEFC) typically has a cell stack which is produced by stacking two or more unit cells. Each of the unit cells comprises: a polymer electrolyte membrane; and an anode and a cathode disposed so as to sandwich the polymer electrolyte membrane. All of the anodes and cathodes include a catalyst layer and a diffusion layer. When a PEFC is a direct methanol fuel cell (DMFC), methanol, as a fuel, is supplied to the anode; and air (oxygen), as an oxidant, is supplied to the cathode.

In a direct oxidant fuel cell (DOFC), fuel crossover tends to occur. This is a phenomenon in which liquid fuel moves from an anode to a cathode, by passing through an electrolyte membrane. When fuel crossover occurs, liquid fuel reaches the cathode, thereby causing an electrochemical oxidation reaction at the cathode catalyst layer. As a result, the cathode potential becomes lower, and the voltage generated becomes lower. DMFC, in particular, uses methanol as liquid fuel; and therefore, when fuel crossover occurs, the methanol moves from the anode to the cathode, by permeating through the electrolyte membrane. Fuel crossover occurring in a DMFC is usually called methanol crossover (MCO).

When methanol crossover (MCO) occurs in a DMFC, it not only lowers the voltage generated, but also lowers fuel utilization efficiency (hereafter, “fuel efficiency”) of methanol serving as liquid fuel. This fuel efficiency is defined by, e.g., the following relational equation (4). In the relational equation (4), the amount of MCO used is converted to current.

fuel efficiency=current generated/(current generated+amount of MCO) (4)

The relational equation (4) shows that fuel efficiency becomes lower, as the amount of MCO increases. That is, increase in the amount of MCO causes increase in the amount of methanol that permeates through the electrolyte membrane to move to the cathode. As a result, the rate of the methanol that contributes to power generation, becomes lower. Thus, energy conversion efficiency in the fuel cell, becomes lower.

Mainly, two approaches are proposed as means to reduce the amount of MCO. The first approach is to improve the electrolyte membrane in terms of either material or structure, so that it would not allow easy permeation of methanol. However, an electrolyte membrane inherently includes water, and this allows the membrane to deliver high ion conductivity. Moreover, methanol easily dissolves in water. Therefore, even if the electrolyte membrane is improved, methanol, dissolved in water, would easily permeate therethrough.

The second approach is to reduce the methanol concentration at the interface between the electrolyte membrane and the anode catalyst layer. Permeation of methanol occurs, mainly due to a difference created between the methanol concentration on the anode side and that on the cathode side. Thus, by reducing the methanol concentration on the anode side, the difference between the concentrations becomes smaller; and as a result, the amount of MCO becomes smaller. Presumably, the most simple and general way to realize this approach, is to dilute methanol with water, and supply the resultant methanol dilution to the anode.

According to the foregoing method, the following would be possible to store water produced by a reaction that occurs in the fuel cell (c.f., reaction formula (3)) in the fuel cell system; and to dilute methanol by utilizing the water. Thus, water to be supplied to the fuel cell system need not be obtained from an outside source; and therefore, it would be possible to improve the energy density in the fuel cell system.

For example, Patent Literature 1 discloses a DMFC system in which methanol supplied from a methanol tank is mixed with water (aqueous methanol solution with low concentration) supplied from a water tank, by using a mixer; and then the resultant mixture is supplied to the anode. In the water tank, the aqueous methanol solution discharged from the anode is mixed with pure water in the tank; and then the resultant mixture is stored. On the other hand, Patent Literature 2 discloses a DMFC system in which methanol supplied from a fuel cartridge is mixed with water supplied from a water collecting tank; and then the resultant mixture is supplied to the anode. In the water collecting tank, water discharged from the cathode is stored.

In general, performance of a fuel cell in generating power degrades over time. The causes for such degradation are reported to be the reduced activity of the electrode catalyst due to impurities such as those in the liquid fuel supplied to the anode and those that flow out of the components which make up the fuel cell; and the reduced ion conductivity of the electrolyte due to an ion exchange reaction occurring in the electrolyte included in the electrolyte membrane and catalyst layer. In particular, when metal cations get mixed in the liquid fuel as impurities, an irreversible ion exchange reaction occurs in the electrolyte included in the electrolyte membrane and catalyst layer. Thus, even if the amount of such metal cations is very small, they greatly affect (degrade) the electrolyte due to their accumulation therein. Therefore, inclusion of metal cations in the electrolyte, is not preferable.

For example, Patent Literature 2 discloses a technique of removing metal ions included in an aqueous methanol solution that is to be supplied to the anode, by passing the solution through a material which adsorbs metal ions.

### CITATION LIST

### Patent Literatures

[Patent Literature 1] Japanese Laid-Open Publication No. 2005-302519
[Patent Literature 2] Japanese Laid-Open Publication No. 2008-084593

### SUMMARY OF INVENTION

### Technical Problem

However, in the system structure disclosed in Patent Literature 1, a mixer needs to be installed in addition to a methanol tank and a water tank, and this may result in increased volume of the system as a whole. Moreover, for the mixer to uniformly mix water and methanol, the system would need to use a mixer having a large capacity, or use complex mechanical parts or stirring device that would enable high stirring performance, thus causing a cost increase. On the other hand, if the system uses a mixer having a small capacity, or uses mechanical parts or stirring device that would cause low stirring performance, it would not be possible to uniformly mix water and methanol; and thus, the methanol concentration in the aqueous methanol solution supplied to the anode would be non-uniform. The non-uniform solution would cause local increase in the amount of MCO, or cause increase in diffusion overvoltage due to local deficiency of the fuel; and this would result in poor power generating performance.

In the system structure disclosed in Patent Literature 2 also, a mixing tank needs to be installed in addition to a fuel cartridge and a water collecting tank, and this may result in increased volume of the system as a whole. Moreover, in the system structure of Patent Literature 2, a gas-liquid separating film is arranged above the mixing tank; and this is used for separating a substance discharged from the anode, into a carbon dioxide gas and an aqueous methanol solution. It is preferable that only the carbon dioxide gas is separated from the aqueous methanol solution. Actually however, methanol supplied from the fuel cartridge partially evaporates, and is separated along with the carbon dioxide gas. The carbon dioxide gas including the methanol gas is discharged out of the system, via an exhaust gas filter. However, usually, it would be difficult for the exhaust gas filter to catch and collect the entire methanol gas. Thus, regarding the system structure of Patent Literature 2, there are concerns that methanol gas would be discharged out of the system, thus adversely affecting safety. Moreover, the methanol caught and collected by the exhaust gas filter cannot be effectively utilized as fuel. Therefore, fuel efficiency becomes lower.

Thus, an object of the present invention is to provide a fuel cell system that is capable of improvement in power generating performance and reduction in size, and furthermore, is very safe.

### Solution to Problem

The fuel cell system according to the present invention comprises a membrane electrode assembly, a fuel tank, a liquid collecting tank, a two-liquid-joining unit, a first fuel supply unit, a second fuel supply unit, and a fuel filter. The membrane electrode assembly has an anode, a cathode, and an electrolyte membrane interposed therebetween. The fuel tank stores a liquid fuel. The liquid collecting tank stores a liquid discharged from at least one of the anode and the cathode, as a collected liquid. The two-liquid-joining unit prepares a diluted fuel, by mixing the liquid fuel supplied from the fuel tank, and the collected liquid supplied from the liquid collecting tank. The first fuel supply unit supplies the liquid fuel to the two-liquid-joining unit. The second fuel supply unit supplies the diluted fuel to the anode. The fuel filter is disposed between the two-liquid-joining unit and the anode, and removes impurities in the diluted fuel.

### Advantageous Effects of Invention

The fuel cell system according to the present invention is capable of improvement in power generating performance and reduction in size, and furthermore, is very safe.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is a view schematically showing the structure of a fuel cell system according to one embodiment of the present invention.

FIG. 2 is a vertical sectional view schematically showing a fuel cell included in the fuel cell system.

### DESCRIPTION OF EMBODIMENTS

First, a description will be given on a fuel cell system according to the present invention.

A fuel cell system according to the present invention comprises a membrane electrode assembly, a fuel tank, a liquid collecting tank, a two-liquid-joining unit, a first fuel supply unit, a second fuel supply unit, and a fuel filter. The membrane electrode assembly has an anode, a cathode, and an electrolyte membrane interposed therebetween. The fuel tank stores a liquid fuel. The liquid collecting tank stores a liquid discharged from at least one of the anode and the cathode, as a collected liquid. The two-liquid-joining unit prepares a diluted fuel, by mixing the liquid fuel supplied from the fuel tank, and the collected liquid supplied from the liquid collecting tank. The first fuel supply unit supplies the liquid fuel to the two-liquid-joining unit. The second fuel supply unit supplies the diluted fuel to the anode. The fuel filter is disposed between the two-liquid-joining unit and the anode, and removes impurities in the diluted fuel.

More specifically, the two-liquid-joining unit is a three-way pipe that is Y-shaped or T-shaped. Moreover, in the fuel cell system, the second fuel supply unit is preferably disposed between the two-liquid-joining unit and the anode. The liquid fuel includes at least one fuel selected from the group consisting of methanol, ethanol, formaldehyde, formic acid, dimethylether, ethylene glycol, and low molecular weight polymers thereof.

In the fuel cell system, the fuel tank stores the liquid fuel, which has high concentration. Therefore, a high energy density can be realized in the system. In addition, in the system, the diluted fuel, which has low fuel concentration, is supplied to the anode. This reduces the amount of fuel crossover. As a result, high fuel efficiency is realized in the system.

In terms of reducing the amount of fuel crossover, it is preferable that the fuel concentration in the diluted fuel is equal to or lower than ½ of, and equal to or higher than 1/30 of a fuel concentration in the liquid fuel in the fuel tank. It is further preferable that the fuel concentration in the liquid fuel stored in the fuel tank is 8 mol/L or higher; and that the fuel concentration in the diluted fuel supplied to the anode is 0.5 to 4 mol/L.

Moreover, in the fuel cell system, the diluted fuel passes through the fuel filter, before being supplied to the anode. Therefore, impurities in the diluted fuel are removed by the fuel filter. Thus, regarding an electrolyte included in the membrane electrode assembly, proton conductivity of the electrolyte does not easily become lower. Moreover, when the diluted fuel passes through the fuel filter, mixing of water and methanol included in the diluted fuel is promoted.

Furthermore, in the fuel cell system, a fuel concentration in the collected liquid in the liquid collecting tank becomes lower than the fuel concentration in the diluted fuel. Thus, a concentration of fuel gas produced in the liquid collecting tank, becomes sufficiently low. Therefore, even if the liquid collecting tank is partially opened to the outside so that the gas in the tank can be discharged out of the system, a small amount of the fuel gas would be discharged from the tank. Thus, even if exhaust gas from the liquid collecting tank is discharged, as is, out of the system, its possibility of adversely affecting the human body and the environment would be low. By allowing exhaust gas to be discharged out of the system via an exhaust gas filter, there would be further improvement in safety of the system.

In the foregoing specific structure of the fuel cell system, the fuel filter includes an ion exchange resin in the form of powder or granules. Further specifically, the ion exchange resin is a cation exchange resin.

The fuel filter composed of the ion exchange resin further promotes mixing of water and methanol in the diluted fuel; and as a result, the fuel concentration in the diluted fuel becomes uniform. Thus, fuel crossover and fuel deficiency are unlikely to occur locally; and as a result, power generating performance is unlikely to degrade. Moreover, the system does not require a mixing tank with a large capacity, and does not require complex mechanical parts or stirring device that would enable high stirring performance, in order to uniformly mix the high concentration liquid fuel supplied from the fuel tank, and the collected liquid supplied from the liquid collecting tank (low concentration liquid fuel mainly composed of water). Thus, according to the foregoing specific structure of the fuel cell system, increase in both the volume and cost of the system as a whole, can be avoided.

In the following, with reference to drawings, a detailed description will be given on a fuel cell system including a direct oxidation fuel cell (DOFC), as an embodiment of the present invention. Note that the present invention is not limited to this embodiment.

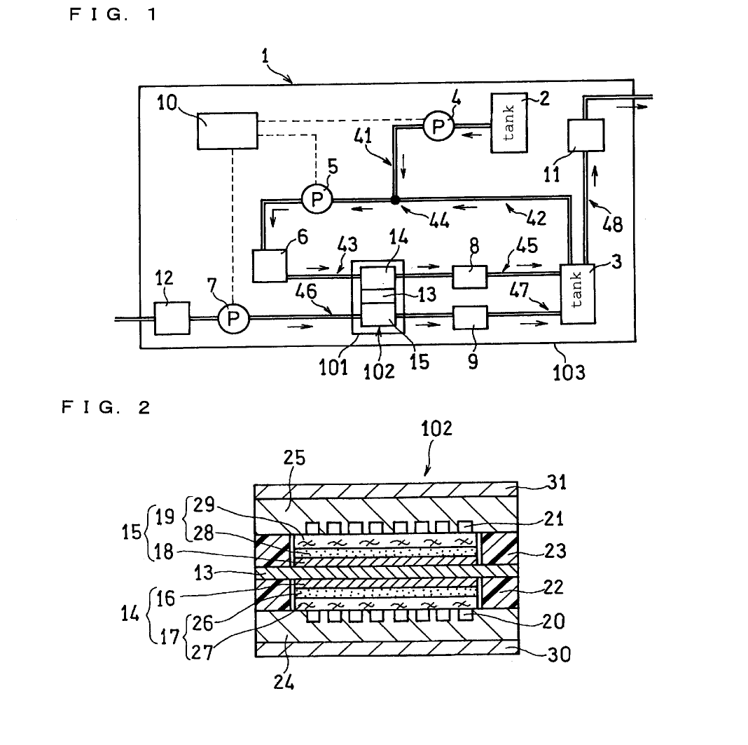

FIG. 1 is a view schematically showing the structure of a fuel cell system according to one embodiment of the present invention. As shown in FIG. 1, a fuel cell system 1 includes a DOFC 101. The DOFC 101 has a fuel cell 102 which serves to generate power.

FIG. 2 is a vertical sectional view schematically showing the structure of the fuel cell 102. As shown in FIG. 2, the fuel cell 102 has an membrane electrode assembly (MEA). The MEA includes an anode 14, a cathode 15, and an electrolyte membrane 13 interposed therebetween. A liquid fuel is supplied to the anode 14, and an oxidant is supplied to the cathode 15. Here, the liquid fuel is a solution containing at least one fuel selected from, e.g., methanol, ethanol, formaldehyde, formic acid, dimethylether, ethylene glycol, and low molecular weight polymers thereof. The oxidant is, e.g., air, compressed air, oxygen, or mixed gas containing oxygen.

When the liquid fuel is an aqueous ethanol solution, the reactions expressed by the aforementioned reaction formulae (1) and (2) occur at the anode 14 and the cathode 15, respectively. As a result, carbon dioxide is produced at the anode 14, and water is produced at the cathode 15.

The anode 14 includes an anode catalyst layer 16 and an anode diffusion layer 17. The anode catalyst layer 16 is laminated on the electrolyte membrane 13, and is thus in contact therewith. That is, the anode catalyst layer 16 is bonded to the electrolyte membrane 13. The anode diffusion layer 17 includes a microporous layer 26 and an anode diffusion layer substrate 27. The microporous layer 26 and the anode diffusion layer substrate 27 are laminated in this order, on the anode catalyst layer 16 (i.e., on the side opposite the side where the electrolyte membrane 13 is positioned).

The anode catalyst layer 16 includes an anode catalyst and a polymer electrolyte. The anode catalyst is preferably a noble metal that is highly catalytically active, such as platinum. In terms of reducing catalyst poisoning due to carbon monoxide, the anode catalyst may be a platinum-ruthenium alloy catalyst. The anode catalyst may take the form of being supported on a support. The support is preferably made of a carbon material that is high in both electron conductivity and acid resistance, e.g., carbon black, etc. The polymer electrolyte is preferably made of a material with proton conductivity such as a perfluorosulfonic acid polymer material or a hydrocarbon polymer material. For the perfluorosulfonic acid polymer, e.g., Nafion® or Flemion® may be used.

The anode catalyst layer 16 can be formed in the following manner. For example, an anode catalyst, a polymer electrolyte, and a dispersion medium such as water or alcohol are mixed, to prepare an ink for forming the anode catalyst layer 16. Here, the anode catalyst may be supported on a support. Next, by doctor blading, spray application, or the like, the prepared ink is applied to a base material sheet or the like made of polytetrafluoroethylene (PTFE). Thereafter, the applied ink is dried to form an anode catalyst layer 16. The anode catalyst layer 16 formed as such is transferred onto the electrolyte membrane 13, by hot pressing or the like. Note that instead of transferring the anode catalyst layer 16 to the electrolyte membrane 13 as above, the anode catalyst layer 16 may be formed directly on the electrolyte membrane 13, by applying the ink to the electrolyte membrane 13 and then drying the resultant.

The cathode 15 includes a cathode catalyst layer 18 and a cathode diffusion layer 19. The cathode catalyst layer 18 is laminated on the electrolyte membrane 13, such that it is in contact with the surface of the electrolyte membrane 13, opposite of the surface where the anode catalyst layer 16 is in contact (i.e., the upper surface of the electrolyte membrane 13, when seen in FIG. 2). That is, the cathode catalyst layer 18 is bonded to the electrolyte membrane 13. The cathode diffusion layer 19 includes a microporous layer 28 and a cathode diffusion layer substrate 29. The microporous layer 28 and the cathode diffusion layer substrate 29 are laminated in this order, on the cathode catalyst layer 18 (i.e., on the side opposite the side where the electrolyte membrane 13 is positioned).

The cathode catalyst layer 18 includes a cathode catalyst and a polymer electrolyte. The cathode catalyst is preferably a noble metal that is highly catalytically active, such as platinum. The cathode catalyst may be an alloy made of platinum and a metal such as cobalt or the like. The cathode catalyst may take the form of being supported on a support. The support can be made of the same carbon material as the one used for the support which supports the anode catalyst, as the foregoing. The polymer electrolyte in the cathode catalyst layer 18 can be made of the same material as the one used for the polymer material in the anode catalyst layer 16. Moreover, the cathode catalyst layer 18 can be formed in the same manner as the anode catalyst layer 16.

Regarding the microporous layers 26 and 28 included in the anode diffusion layer 17 and the cathode diffusion layer 19, respectively, each includes a conductive agent and a water repellent agent. The conductive agents in the microporous layers 26 and 28, respectively, can be of any material usually used in the field of fuel cells. Specifically, examples of the conductive agents include carbon powder materials such as carbon black and flake graphite; and carbon fibers such as carbon nanotubes and carbon nanofibers. For each of the conductive agents, only one may be selected from these materials and used singly; or, two or more may be selected therefrom and used in combination.

The water repellent agents in the microporous layers 26 and 28 can be of any material usually used in the field of fuel cells. Each of the water repellent agents is preferably, e.g., a fluorocarbon resin. This fluorocarbon resin can be any known material. Examples of the fluorocarbon resin include polytetrafluoroethylene, (PTFE), tetrafluoroethylene-hexafluoropropylene copolymer resin (FEP), tetrafluoroethylene-perfluoro(alkyl vinyl ether) copolymer resin, tetrafluoroethylene-ethylene copolymer resin, and polyvinylidene fluoride. Among the above listed, PTFE and FEP are preferred. For each of the water repellent agents, only one may be selected from these materials and used singly; or, two or more may be selected therefrom and used in combination.

The microporous layers 26 and 28 are formed on surfaces of the anode diffusion layer substrate 27 and the cathode diffusion layer substrate 29, respectively. The microporous layers 26 and 28 can be formed in any manner. For example, a conductive agent and a water repellent agent are dispersed in a predetermined dispersion medium, to prepare a paste for forming the microporous layers 26 and 28. Next, by doctor blading, spray application, or the like, the prepared paste is applied to the surfaces of the anode diffusion layer substrate 27 and the cathode diffusion layer substrate 29. Thereafter, the applied paste is dried. As such, the microporous layers 26 and 28 can be formed on the surfaces of the anode diffusion layer substrate 27 and the cathode diffusion layer substrate 29, respectively.

Regarding the materials for the anode diffusion layer substrate 27 and the cathode diffusion layer substrate 29, respectively, each is a porous material with conductivity. Such a porous material can be any material usually used in the field of fuel cells; and is particularly preferably a material that enables easy diffusion of fuel or oxidant, and has high electron conductivity. Examples of such a material include carbon paper, carbon cloth, and non-woven carbon fabric. The porous material may include a water repellent agent so as to improve diffusion of fuel, discharge of water produced, etc. The water repellent agent can be of the same material as the one in the microporous layers. For example, the water repellent agent can be included in the porous material in the following manner, although not limited to such a manner. That is, the porous material is immersed in the water repellent agent in the form of a dispersion; and thereafter, the resultant porous material is dried. Thus, the porous material including the water repellent agent is obtained, to be used as each of the anode diffusion layer substrate 27 and the cathode diffusion layer substrate 29.

The electrolyte membrane 13 can be any proton conductive polymer membrane, although not limited thereto, examples thereof including perfluorosulfonic acid polymer membrane and hydrocarbon polymer membrane. Examples of the perfluorosulfonic acid polymer membrane include Nafion® or Flemion®. Examples of the hydrocarbon polymer membrane include sulfonated polyether ether ketone and sulfonated polyimide. As the electrolyte membrane 13, the hydrocarbon polymer membrane is particularly preferred. By using the hydrocarbon polymer membrane as the electrolyte membrane 13, formation of the cluster structure of a sulfonic acid group is inhibited at the electrode membrane 13. As a result, fuel permeability of the electrolyte membrane 13 is reduced. This enables reduction in fuel crossover. Note that the electrolyte membrane 13 preferably has a thickness of 20 μm to 150 μm.

The laminate comprising the electrolyte membrane 13, the anode catalyst layer 16, and the cathode catalyst layer 18 serves to generate power in the fuel cell. Note that the laminate is called CCM (Catalyst Coated Membrane). Moreover, the anode diffusion layer 17 serves to uniformly disperse the liquid fuel supplied to the anode 14, and to smoothly discharge the carbon dioxide produced at the anode 14. Furthermore, the cathode diffusion layer 19 serves to uniformly disperse the oxidant supplied to the cathode 15, and to smoothly discharge the water produced at the cathode 15.

In the direction in which the anode 14, the electrolyte membrane 13, and the cathode 15 are laminated, an anode separator 24 is laminated on the anode 14 (i.e., on the lower side of the anode 14, when seen in FIG. 2), and furthermore, a current collector plate 30 is disposed on the outer surface of the anode separator 24. Moreover, in the laminating direction as the foregoing, a cathode separator 25 is laminated on the cathode 15 (i.e., on the upper side of the cathode 15, when seen in FIG. 2), and furthermore, a current collector plate 31 is disposed on the outer surface of the cathode separator 25. An insulating plate and an end plate (both not shown) are stacked on each of the current collector plates 30 and 31. The resultant is clamped together via the end plates. Thus, the MEA is held between the anode separator 24 and the cathode separator 25. Current produced through power generation by the MEA is collected by the current collector plates 30 and 31. A circuit such as a DC/DC converter is connected to the current collectors 30 and 31, and the output voltage from the MEA is converted to a predetermined voltage. The predetermined voltage is output from the fuel cell system to the outside.

Voltage generated by the fuel cell 102 is usually lower than 1 V. Thus, in the DOFC 101, typically, two or more of the fuel cell 102 are stacked, thereby building a cell stack in which the stacked fuel cells 102 are electrically connected in series. In the cell stack, the current collector plates 30 and 31 are not disposed on each of the fuel cells 102; but are disposed only at the ends, respectively, of the cell stack in the direction in which the fuel cells 102 are stacked.

The anode separator 24 has a fuel flow channel 20 formed on a surface of the anode separator 24 which comes in contact with the anode diffusion layer substrate 27. The fuel flow channel 20 has an inlet for supplying the liquid fuel to the anode 14, and an outlet for discharging the carbon dioxide from the anode 14. The fuel flow channel 20 takes the form of, e.g., recess or groove which is open toward the anode diffusion layer substrate 27.

The cathode separator 25 has an oxidant flow channel 21 formed on a surface of the cathode separator 25 which comes in contact with the cathode diffusion layer substrate 29. The oxidant flow channel 21 has an inlet for supplying the oxidant to the cathode 15, and an outlet for discharging the water from the cathode 15. The oxidant flow channel 21 takes the form of, e.g., recess or groove which is open toward the cathode diffusion layer substrate 29.

A gasket 22, which seals the anode 14 by surrounding the same, is disposed between the electrolyte membrane 13 and the anode separator 24. This prevents the liquid fuel supplied to the anode 14, from leaking out of the fuel cell 102. Moreover, a gasket 23, which seals the cathode 15 by surrounding the same, is disposed between the electrolyte membrane 13 and the cathode separator 25. This prevents the oxidant supplied to the cathode 15, from leaking out of the fuel cell 102.

The fuel cell 102 shown in FIG. 2 can be produced, e.g., in the following manner. First, by hot pressing or the like, the anode 14 and the cathode 15 are bonded to the surfaces, respectively, of the electrolyte membrane 13, thereby producing an MEA. Next, the MEA is held between the anode separator 24 and the cathode separator 25. At that time, the gasket 22 is disposed between the electrolyte membrane 13 and the anode separator 24, such that it surrounds the anode 14, so as to seal the anode 14. Moreover, the gasket 23 is disposed between the electrolyte membrane 13 and the cathode separator 25, such that it surrounds the cathode 15, so as to seal the cathode 15. Thereafter, the current collector plate 30, the insulating plate, and the end plate are stacked on the outer side of the anode separator 24; and the current collector plate 31, the insulating plate, and the end plate are stacked on the outer side of the cathode separator 25. Then, the resultant is clamped together via the end plates. Furthermore, a heater for temperature adjustment is stacked on the outer side of the end plates. Thus, a fuel cell 102 is produced.

As shown in FIG. 1, the fuel cell system 1 comprises the following in addition to the DOFC 101: a fuel tank 2, a liquid collecting tank 3, a first fuel supply unit 4, a second fuel supply unit 5, a fuel filter 6, an oxidant supply unit 7, an anode heat exchange unit 8, a cathode heat exchange unit 9, a control unit 10, an exhaust gas filter 11, and an oxidant filter 12. The fuel cell system 1 further comprises: a fuel pipe 41, a collected liquid pipe 42, an anode supply pipe 43, a two-liquid-joining unit 44, an anode discharge pipe 45, a cathode supply pipe 46, a cathode discharge pipe 47, and an exhaust pipe 48.

The fuel tank 2 stores the liquid fuel which has high concentration. In the present embodiment, the fuel tank 2 is disposed in a housing 103 of the fuel cell system 1. The higher the fuel concentration is in the liquid fuel, the larger the amount of energy would be for the liquid fuel, and also, the higher the energy density would be in the fuel cell system 1. Thus, the liquid fuel stored in the fuel tank 2 preferably has a fuel concentration that is at least 8 mol/L or higher. The fuel tank 2 may be disposed outside of the housing 103, and also when disposed as such, the fuel tank 2 is regarded as a component of the fuel cell system 1. Alternatively, a fuel cartridge containing the high concentration liquid fuel may be used, in place of the fuel tank 2.

The liquid collecting tank 3 collects and stores, as a collected liquid, a liquid fuel with low concentration to be used as a diluted solvent. Specifically, the liquid collecting tank 3 is connected to the anode discharge pipe 45 leading to the outlet of the fuel flow channel 20 in the fuel cell 102, and to the cathode discharge pipe 47 leading to the outlet of the oxidant flow channel 21 in the fuel cell 102. The following flows through the anode discharge pipe 45: gas such as carbon dioxide or the like produced at the anode 14 (c.f., reaction formula (1) in the foregoing); by-product; unconsumed fuel that has remained in the diluted fuel (to be described later); and water. The following flows through the cathode discharge pipe 47: liquid such as water or the like produced at the cathode 15 (c.f., reaction formula (2) in the foregoing); and unconsumed oxidant that has remained. Thus, these substances discharged from the fuel cell 102 flow into the liquid collecting tank 3.

Unconsumed fuel, water, and by-product, partially in a vaporized state, flow through the anode discharge pipe 45. Therefore, in the present embodiment, the anode heat exchange unit 8 is disposed on the anode discharge pipe 45. At the anode heat exchange unit 8, there is heat exchange between water vapor, fuel gas, and by-product gas, and outside air, whereby these gases are cooled and liquefied. Moreover, at the anode heat exchange unit 8, not only gas, but also liquid undergoes heat exchange with outside air, whereby the liquid is cooled. As such, heat in the fuel cell system 1 is released to the outside.

The water produced at the cathode 15, partially being water vapor, flows through the cathode discharge pipe 47. Therefore, in the present embodiment, the cathode heat exchange unit 9 is disposed on the cathode discharge pipe 47. At the cathode heat exchange unit 9, there is heat exchange between water vapor and outside air, whereby the water vapor is cooled and liquefied. Moreover, at the cathode heat exchange unit 9, not only water, but liquid and oxidant also undergo heat exchange with outside air, whereby the liquid and oxidant are cooled. As such, heat in the fuel cell system 1 is released to the outside.

Furthermore, a gas-liquid separating mechanism is disposed in the liquid collecting tank 3. In the present embodiment, a gas-liquid separation film is disposed at the upper portion of the liquid collecting tank 3. Thus, in the liquid collecting tank 3, the discharged substances that flow therein are separated into liquid components (fuel, water, by-product, etc.) and gas components (by-product gas, water vapor, carbon dioxide, oxidant, etc.) The gas components are discharged out of the fuel cell system 1, via the exhaust pipe 48. Meanwhile, the liquid components are collected and stored as the collected liquid, in the liquid collecting tank 3.

As described in the foregoing, in addition to the unconsumed fuel, the water produced at the cathode 15 flows into the liquid collecting tank 3. Therefore, the fuel concentration in the collected liquid in the liquid collecting tank 3 is lower than the fuel concentration in the diluted fuel flowing through the anode discharge pipe 45. Specifically, the fuel concentration in the collected liquid is 0.05 to 0.5 mol/L. If the following requirement is met, only the liquid discharged from either one of the anode 14 and the cathode 15 may be stored as the collected liquid, in the liquid collecting tank 3: the fuel concentration in the collected liquid in the liquid collecting tank 3 is lower than the fuel concentration in the diluted fuel flowing through the anode discharge pipe 45.

When the fuel concentration in the collected liquid is low as in the foregoing, the concentration of fuel gas produced in the liquid collecting tank 3 becomes sufficiently low. Thus, the amount of fuel gas discharged via the exhaust pipe 48 becomes small. Therefore, even when exhaust gas from the liquid collecting tank 3 is discharged, as is, out of the fuel cell system 1, there is little possibility of its adversely affecting the human body and the environment. However, the structure described below would enable further improvement in safety of the fuel cell system 1.

In the present embodiment, the exhaust gas filter 11 for catching and collecting fuel gas and by-product gas, is disposed on the exhaust pipe 48. The exhaust gas filter 11 is, e.g., a filter including a material such as an activated carbon or the like which absorbs or sticks toxic substances. Therefore, gas components with the possibility of adversely affecting the human body and the environment, are removed by the exhaust gas filter 11. The exhaust gas filter 11 may be a filter, such as a catalytic filter, which oxidizes toxic substances in exhaust gas to make them non-toxic.

As shown in FIG. 1, the fuel pipe 41 is connected to the fuel tank 2, and the liquid fuel from the fuel tank 2 flows through the fuel pipe 41. The collected liquid pipe 42 is connected to the liquid collecting tank 3, and the collected liquid from the liquid collecting tank 3 flows though the collected liquid pipe 42. The fuel pipe 41 and the collected liquid pipe 42 are connected via the two-liquid-joining unit 44.

The two-liquid-joining unit 44 has three ports. The fuel pipe 41 is connected to the first port, and the collected liquid pipe 42 is connected to the second port. The anode supply pipe 43 is connected to the remaining third port. The anode supply pipe 43 is connected to the DOFC 101, and leads to the inlet of the fuel flow channel 20. At the two-liquid-joining unit 44, the high concentration liquid fuel flowing from the fuel pipe 41 is mixed with the collected liquid flowing from the collected liquid pipe 42. That is, the high concentration liquid fuel is diluted with the collected liquid, thereby preparing a diluted fuel. At that time, a fuel concentration in the diluted fuel is adjusted to become ½ to 1/30 of the fuel concentration in the liquid fuel in the fuel tank 2. The diluted fuel adjusted as such flows through the anode supply pipe 43.

The two-liquid-joining unit 44 is, e.g., a three-way pipe. The three-way pipe is preferably a pipe with a Y shape (Y-shaped pipe) or a T shape (T-shaped pipe), and may have a check valve for backflow prevention. As an alternative to the three-way pipe, the two-liquid-joining unit 44 may have a structure in which an end portion of the fuel pipe 41, like a nozzle, extends into the collected liquid pipe 42, and extends such that the liquid fuel spurts out of the tip of the end portion in the direction of the central axis of the collected liquid pipe 42. However, use of a Y-shaped or T-shaped pipe would more easily lower costs and save space.

The first fuel supply unit 4 is disposed on the fuel pipe 41, at a position between the fuel tank 2 and two-liquid-joining unit 44; and supplies the liquid fuel in the fuel tank 2, to the two-liquid-joining unit 44. The first fuel supply unit 4 typically has a driving source such as a liquid pump or the like. The first fuel supply unit 4 may also be without a driving source, i.e., it can utilize a phenomenon such as capillary osmosis. The liquid pump is typically a diaphragm pump which uses a motor as the driving source, or the like. The liquid pump can be a pump which utilizes a piezoelectric element, a pump which utilizes electroendosmosis, or the like.

The second fuel supply unit 5 is disposed on the anode supply pipe 43, at a position between the two-liquid-joining unit 44 and the anode 14; and supplies the diluted fuel prepared at the two-liquid-joining unit 44, to the anode 14. The second fuel supply unit 5 typically is a liquid pump. The liquid pump is typically a diaphragm pump which uses a motor as the driving source, or the like. The liquid pump can be a centrifugal pump, a gear pump, or the like.

In the present embodiment, the second fuel supply unit 5 is disposed on the anode supply pipe 43, at a position between the two-liquid-joining unit 44 and the fuel filter 6 described below. The structure of the present invention is not limited to the above, and the second fuel supply unit 5 may be disposed on the anode supply pipe 43, at a position between the fuel filter 6 and the anode 14. Alternatively, the second fuel supply unit 5 may be disposed on the collected liquid pipe 42, at a position between the liquid collecting tank 3 and the two-liquid-joining unit 44.

As described in the foregoing, the fuel concentration in the diluted fuel is ½ to 1/30 of the fuel concentration in the liquid fuel in the fuel tank 2. Thus, to obtain the same power generating performance as when the liquid fuel in the fuel tank 2 is supplied, as is, to the anode 14, it is necessary to significantly increase the amount of liquid sent out by the second fuel supply unit 5 per unit time, to be 2 to 30 times the amount of liquid sent out by the first fuel supply unit 4 per unit time. Therefore, the second fuel supply unit 5 is preferably disposed on the anode supply pipe 43, at a position between the two-liquid-joining unit 44 and the anode 14. This is because when the second fuel supply unit 5 is disposed between the liquid collecting tank 3 and the two-liquid-joining unit 44, a large amount of the liquid (in this case, the collected liquid) sent out by the second fuel supply unit 5 flows backward in the fuel pipe 41 via the two-liquid-joining unit 44, or cause increased pressure at the outlet of the fuel pipe 41. Thus, the first fuel supply unit 4 is burdened with load, and as a result, problems such as reduced precision in supplying of the fuel (i.e., loss of stability in the fuel concentration and the supply amount of the diluted fuel supplied to the anode 14), and shortened life of the fuel pump, tend to occur easily.

The fuel filter 6 is disposed on the anode supply pipe 43, at a position between the two-liquid-joining unit 44 and the anode 14. Here, the fuel filter 6 has two important functions. The first function is the removal of impurities in the diluted fuel. The second function is the uniform mixing of water and fuel in the diluted fuel.

Impurities include those that get mixed in the fuel itself, and those that flow out of the pipes, connecting members, sealing components in the electrodes, fuel pumps, heat exchanger, etc. which are components comprising the fuel cell system 1. Impurities contain, e.g., cations. Cations irreversibly cause degradation of the electrolyte included in each of the electrolyte membrane 13, anode catalyst layer 16, and cathode catalyst layer 18 in the fuel cell 102. Specifically, cations bond to ion exchange groups in the electrolyte, thereby causing significant degradation of the proton conductivity of the electrolyte. Thus, if cations flow into the fuel cell 102, resistance to ion conductivity would significantly increase at the electrolyte membrane 13, the anode catalyst layer 16, and the cathode catalyst layer 18. Therefore, there is a very high necessity to remove cations in particular among impurities, by using the fuel filter 6.

Therefore, to make the first function effective in removing cations in particular among impurities, the fuel filter 6 preferably includes an ion exchange resin characterized by cation exchange (cation exchange resin). The ion exchange resin is preferably in the form of a powder or granules, and is filled in a container or the like made of resin. Here, the average particle size of the ion exchange resin is 100 to 1000 μm. Note that the fuel filter 6 may also include an ion exchange resin characterized by anion exchange (anion exchange resin), so that it would also remove anions, being impurities, in addition to cations. Moreover, the fuel filter 6 may also include an activated carbon filter or the like for removing organic impurities.

Use of an ion exchange resin as a component of the fuel filter 6 is preferable, also in terms of the fuel filter 6 having the second function. The reason is presumably as follows. Since an ion exchange resin is capable of high absorption of liquids, it partially absorbs the diluted fuel that attempts to pass through the fuel filter 6. The flow velocity of the diluted fuel absorbed by the ion exchange resin becomes significantly low inside the ion exchange resin. In contrast, the flow velocity of the diluted fuel flowing through the vacant space in the ion exchange resin, hardly becomes low. Therefore, the flow velocity of the diluted fuel becomes partially low in the fuel filter 6. As a result, the diluted fuel is stirred with high efficiency, and this promotes mixing of water and fuel in the diluted fuel. Thus, by the diluted fuel passing though the fuel filter 6, the fuel concentration in the diluted fuel becomes uniform; and in this state, the diluted fuel is supplied to the anode 14.

Most of the diluted fuel supplied to the anode 14 moves to the anode catalyst layer 16 from the fuel flow channel 20, via the anode diffusion layer 17, due to the phenomenon of concentration diffusion. Thus, a reaction occurs at the anode 14. When the diluted fuel is an aqueous ethanol solution, the reaction expressed by the reaction formula (1) occurs at the anode 14. As a result, carbon dioxide is produced at the anode 14. The carbon dioxide is discharged from the anode 14, via the fuel flow channel 20. At that time, the fuel that did not contribute to the reaction and the fuel that did not move to the anode catalyst layer 16 are discharged, together with the carbon dioxide, from the anode 14, via the fuel flow channel 20.

A cathode supply pipe 46 is connected to the DOFC 101; and leads to the inlet of the oxidant flow channel 21. An oxidant supply unit 7 is disposed on the cathode supply pipe 46. The oxidant supply unit 7 takes the oxidant into the cathode supply pipe 46; and supplies that oxidant to the cathode 15. Note that oxygen in air is typically used as the oxidant. In this case, air is taken into the cathode supply pipe 46, from, e.g., outside of the fuel cell system 1. Alternatively, the oxidant supply unit 7 is, e.g., an air pump.

The oxidant filter 12 is disposed on the cathode supply pipe 46, at a position opposite that of the DOFC 101, with respect to the oxidant supply unit 7. The oxidant filter 12 catches and collects impurities in the oxidant taken into the cathode supply pipe 46, to remove impurities from the oxidant. Note that when the oxidant is air, the oxidant filter 12 is, e.g., an air filter. The air filter catches and collects impurities in air, such as dust, organic gas, and inorganic gas which would adversely affect power generation.

Most of the oxidant supplied to the cathode 15 moves to the cathode catalyst layer 18 from the oxidant flow channel 21, via the cathode diffusion layer 19, due to the phenomenon of concentration diffusion. Thus, a reaction occurs at the cathode 15. When the oxidant is oxygen, the reaction expressed by the reaction formula (2) occurs at the cathode 15. As a result, water is produced at the cathode 15. The water is discharged from the cathode 15, via the oxidant flow channel 21. At that time, the oxidant that did not contribute to the reaction and the oxidant that did not move to the cathode catalyst layer 18 are discharged, together with the water, from the cathode 15, via the oxidant flow channel 21.

Among the first fuel supply unit 4, the second fuel supply unit 5, and the oxidant supply unit 7, the control unit 10 particularly controls the supply unit that has a driving source. FIG. 1 shows the case where the control unit 10 controls all of the supply units. In the following, a description will be given on the case where both of the first fuel supply unit 4 and the second fuel supply unit 5 are liquid pumps.

The control unit 10 first detects current generated in the DOFC 101. Then, based on the current generated, the control unit 10 controls the first fuel supply unit 4 and the second fuel supply unit 5, by sending them control signals. Specifically, the control unit 10 makes the first fuel supply unit 4 and the second fuel supply unit 5 adjust the supply amount of the liquid fuel and that of the diluted fuel, respectively.

More specifically, by the control unit 10, the first fuel supply unit 4 is controlled so that there would be balance between the consumed amount of the fuel (i.e., the fuel amount that contributes to power generation, and the fuel amount that is lost due to fuel crossover, in total) and the supply amount of the fuel. By maintaining the balance between the consumed amount and the supply amount, the fuel concentration in the diluted fuel supplied to the anode 14 would be maintained at a target concentration, even without having the fuel concentration sensor monitor the fuel concentration.

Moreover, by the control unit 10, the second fuel supply unit 5 is controlled so that the supply amount of the diluted fuel would be within a predetermined range. Here, the predetermined range is defined such that there would be no increase in concentration overvoltage that occurs near the outlet of the fuel flow channel 20; and no increase in the amount of fuel crossover near the inlet of the fuel flow channel 20. Note that if the supply amount of the diluted fuel is too small, the foregoing concentration overvoltage would increase, and as a result, the voltage generated would become low. Alternatively, if the supply amount of the diluted fuel is too large, the foregoing amount of crossover would increase.

Typically, the supply amount of the diluted fuel to the anode 14 is adjusted based on a stoichiometric ratio of the fuel amount in the diluted fuel that is supplied to the fuel amount that contribute to power generation at the anode 14. Note that the stoichiometric ratio is preferably within a range of 1.3 to 2.5. When the supply amount of the diluted fuel is adjusted such that the stoichiometric ratio is within the range of 1.3 to 2.5, a fuel concentration in the liquid discharged from the anode 14 becomes about ⅛ to ⅔ of a fuel concentration in the diluted fuel that is supplied. For example, when the diluted fuel with a fuel concentration of 1 mol/L is supplied to the anode 14, the liquid with a fuel concentration of about 0.12 to 0.7 mol/L is discharged from the anode 14.

Moreover, the fuel concentration in the diluted fuel is preferably a value that would maximize power generating efficiency. Note that the power generating efficiency is defined by the following relational equations (5) and (6).

Power generating efficiency=Voltage generated/Theoretical voltage E×Fuel efficiency (5)

Theoretical voltage E=−ΔG/nF (6)

(G: Gibbs free energy, n: number of electrons involved in reaction, F: Faraday constant)

In the DOFC 101, the theoretical voltage E is 1.21 V. Moreover, in the DOFC 101, to inhibit reduction of the voltage generated by suppressing the amount of fuel crossover, the fuel concentration in the diluted fuel supplied to the anode 14 is preferably within the range of 0.5 to 4 mol/L.

In the fuel cell system 1 according the present embodiment, the fuel tank 2 (or fuel cartridge) stores the high concentration liquid fuel. Therefore, a high energy density is realized in the fuel cell system 1. In addition to the foregoing, in the fuel cell system 1, the diluted fuel with a low fuel concentration is supplied to the anode 14. Thus, the amount of fuel crossover is reduced; and as a result, high fuel efficiency is realized in the fuel cell system 1.

Moreover, in the fuel cell system 1, the diluted fuel passes through the fuel filter 6, before being supplied to the anode 14. Therefore, impurities in the diluted fuel are removed by the fuel filter 6. Thus, proton conductivities of the electrolyte in the electrolyte membrane 13, anode catalyst layer 16, and cathode catalyst layer 18, do not easily become low.

The fuel filter 6 composed of an ion exchange resin promotes mixing of water and fuel in the diluted fuel; and as a result, the fuel concentration in the diluted fuel becomes uniform. Thus, local methanol crossover and local fuel deficiency do not occur easily; and as a result, power generating performance does not degrade easily. Moreover, the fuel cell system 1 does not require a mixing tank with a large capacity, and does not require complex mechanical parts or stirring device which enables high stirring performance, for uniformly mixing the high concentration liquid fuel supplied from the fuel tank 2, and the collected liquid (low concentration liquid fuel, mainly composed of water) supplied from the liquid collecting tank 3. Thus, according to the fuel cell system 1, increase in both the volume and cost of the system as a whole, can be avoided.

Furthermore, in the fuel cell system 1, the liquid collecting tank 3 is made open to the outside, due to the exhaust pipe 48. However, the fuel concentration in the collected liquid in the liquid collecting tank 3 is lower than the fuel concentration in the diluted fuel flowing through the anode discharge pipe 45. Thus, the concentration of fuel gas produced in the liquid collecting tank 3 becomes sufficiently low. Thus, the amount of the fuel gas discharged via the exhaust pipe 48, is small. Therefore, even if exhaust gas from the liquid collecting tank 3 is discharged, as is, out of the fuel cell system 1, its possibility of adversely affecting the human body and the environment would be low. The exhaust gas filter 11 disposed on the exhaust pipe 48 as in the present embodiment, further improves safety of the fuel cell system 1.

### EXAMPLES

### Example 1

### (a) Production of Anode Catalyst Layer

To produce an anode catalyst layer 16, a supported anode catalyst including: an anode catalyst; and a catalyst support supporting the anode catalyst, was used. The anode catalyst used was a Pt—Ru catalyst (atomic ratio 1:1). The anode catalyst support used was carbon black (trade name: Ketjen black ECP, available from Ketjen Black International Company). Regarding the supported anode catalyst, in terms of weight, the proportion of the Pt—Ru catalyst relative to the total of the Pt—Ru catalyst and the Ketjen black, was 50% by weight.

An aqueous isopropanol solution dispersed with the supported anode catalyst, was mixed with a dispersion of Nafion® (i.e., 5 wt % Nafion solution, available from Sigma Aldrich Japan K.K.) serving as a polymer electrolyte, to prepare an ink for producing an anode catalyst layer. The ink was applied onto a polytetrafluoroethylene (PTFE) sheet, by doctor blading; and then the resultant was dried. Thus, an anode catalyst layer 16 was obtained.

### (b) Production of Cathode Catalyst Layer

To produce a cathode catalyst layer 18, a supported cathode catalyst including: a cathode catalyst; and a catalyst support supporting the cathode catalyst, was used. The cathode catalyst used was carbon black (trade name: Ketjen black ECP, available from Ketjen Black International Corporation), same as the one used in the anode catalyst. Regarding the supported cathode catalyst, in terms of weight, the proportion of the Pt catalyst relative to the total weight of the Pt catalyst and the carbon black, was 50 wt %. By using this supported cathode catalyst, a cathode catalyst layer 18 was produced in the same manner as the anode catalyst layer 16.

### (c) Production of Anode Diffusion Layer

(Production of Anode Diffusion Layer Substrate)

Carbon paper (TGP-H-090, available from Toray Industries, Inc.; thickness: 270 μm) was used as a conductive porous material for producing an anode diffusion layer substrate 27. This carbon paper was immersed in a PTFE dispersion (available from Sigma Aldridge Japan K.K.), the PTFE therein serving as a water repellent agent; and then the resultant was dried. As such, the carbon paper was made water-repellent. Thus, an anode diffusion layer substrate 27 was obtained.

(Production of Microporous Layer)

A dispersion of a water repellent agent, and a conductive agent, were dispersed and mixed in an ion-exchanged water to which a predetermined surfactant had been added, to prepare a paste for producing a microporous layer. As the dispersion, a PTFE dispersion (available from Sigma Aldridge Japan K.K.; PTFE content: 60 mass %) was used. As the conductive agent, acetylene black (Denka Black, available from Denki Kagaku Kogyo K.K.) was used.

Subsequently, the microporous layer paste was applied to one surface of the anode diffusion layer substrate 27; and then the resultant was dried, to produce a microporous layer 26. As such, an anode diffusion layer 17 was produced.

### (d) Production of Cathode Diffusion Layer

(Production of Cathode Diffusion Layer Substrate)

A carbon cloth (AvCarb® 1071HCB, available from Ballard Material Products) was used as a conductive porous material for producing a cathode diffusion layer substrate 29. This carbon cloth was treated to be given water repellency, as with the case of the anode diffusion layer substrate 27. Thus, a cathode diffusion layer substrate 29 was produced.

(Production of Microporous Layer)

A paste, same as the microporous layer paste used to produce the anode diffusion layer 17, was prepared. Next, the prepared paste was applied to one surface of the cathode diffusion layer substrate 29; and then the resultant was dried, to produce a microporous layer 28. As such, a cathode diffusion layer 19 was produced.

### (e) Production of Membrane Electrode Assembly (MEA)

First, Nafion®, available from E.I. Dupont de Nemours and Company, was prepared for an electrolyte membrane 13. Then, the anode catalyst layer 16, formed on a PTFE sheet, and the cathode catalyst layer 18, also formed on a PTFE sheet, were laminated on surfaces, respectively, of the electrolyte membrane 13. At this time, regarding each of these layers, a surface opposite a surface in contact with the PTFE sheet, was made to come in contact with the electrolyte membrane 13. Next, by hot pressing, the anode catalyst layer 16 and the cathode catalyst layer 18 were bonded to the electrolyte membrane 13. Thereafter, the PTFE sheets were separated from the anode catalyst layer 16 and the cathode catalyst layer 18, respectively.

Subsequently, by hot pressing, the anode diffusion layer 17 was bonded to the anode catalyst layer 16; and the cathode diffusion layer 19 was bonded to the cathode catalyst layer 18. As such, an MEA was produced. Note that the electrode was square-shaped, each side being 18 mm.

### (f) Production of Direct Oxidation Fuel Cell (DOFC)

Gaskets 22 and 23 made of rubber were disposed on both surfaces, respectively, of the electrolyte membrane 13, such that: the gaskets 22 and 23 covered an exposed part of the electrolyte membrane 13; and they surrounded the anode 14 and the cathode 15, respectively. Then, an anode separator 24 was laminated on the MEA, such that the anode 14 was interposed between the separator 24 and the electrolyte membrane 13. Moreover, a cathode separator 25 was laminated on the MEA, such that the cathode 15 was interposed between the separator 25 and the electrolyte membrane 13. Thus, the MEA was held between the anode separator 24 and the cathode separator 25. Note that before the anode separator 24 was laminated on the MEA, a fuel flow channel 20 for supplying the fuel was formed on the anode separator 24 at the surface in contact with the anode 14. Moreover, note that before the cathode separator 25 was laminated on the MEA, an oxidant flow channel 21 for supplying the oxidant was formed on the cathode separator 25 at the surface in contact with the cathode 15. The shapes of the fuel flow and oxidant flow channels were made serpentine. As such, a direct oxidant fuel cell 102 was produced.

Ten of the fuel cell 102 were produced in the same manner as the foregoing, and were stacked in order. Next, regarding the anode separator 24 and the cathode separator 25 positioned at one end and the other end, respectively, of the stack of the fuel cells 102 in the stacking direction, a current collector plate, an insulating plate, and an end plate were stacked in this order, on each of the separators. The resultant stack was clamped by a predetermined clamping means. Thereafter, a heater for temperature adjustment was attached to the outer side of the separators. Furthermore, a manifold was connected to inlets of the fuel flow channels 20, so that flow channels leading to the inlets would be brought into one. Similarly, flow channels leading to outlets of the fuel flow channels 20 were brought into one; flow channels leading to inlets of the oxidant flow channels 21 were brought into one; and flow channels leading to outlets of the oxidant flow channels 21 were brought into one. As such, a cell stack was produced, and a DOFC 101 was produced by using the cell stack.

### (g) Production of Fuel Cell System

A precision pump (personal pump NP-KX series (product name)) available from Nihon Seimitsu Kagaku Co., Ltd. was used as each of a first fuel supply unit 4 and a second fuel supply unit 5. A personal computer was used as a control unit 10. The personal computer controlled the precision pumps, thereby adjusting the flow rate of a liquid fuel flowing through a fuel pipe 41 and the flow rate of a diluted fuel flowing through an anode supply pipe 43. A methanol of 100% concentration serving as the liquid fuel was filled in a fuel tank 2. The flow rates of the liquid fuel and diluted fuel were adjusted, so that fuel concentration in the diluted fuel supplied to the anode 14 would be 1 mol/L.

A high pressure air cylinder for supplying compressed air, and a massflow controller available from HORIBA, Ltd. for adjusting the flow rate of the compressed air, were used for an oxidant supply unit 7. The personal computer serving as the control unit 10 controlled the massflow controller, thereby adjusting the flow rate of the compressed air flowing through a cathode supply pipe 46.

A resin container made of polypropylene was used as a liquid collecting tank 3. A cathode discharge pipe 47 and an exhaust pipe 48 were connected to upper portions of the resin container; and an anode discharge pipe 45 and a collected liquid pipe 42 were connected to lower portions of the resin container. The collected liquid pipe 42 and the fuel pipe 41 were connected via a Y-shaped pipe made of polypropylene resin.

Strongly acidic cation exchange resin, sulfonated polystyrene-based and proton-type, was used as a material to form a fuel filter 6. Specifically, 100 g of the acidic cation exchange resin in particle form, with an average particle size of 500 μm and an apparent density of 830 g/L, was prepared; and the prepared resin was filled in a polypropylene-made columnar case with an inner diameter of 4 cm and a height of 10 cm, to form a fuel filter 6. Note that the true density of the acidic cation exchange resin in particle form, filled in the case, was about 130 g/L. Thus, there was actually 65% of vacant space created between particles of the acidic cation exchange resin.

A stainless steel-made fin tube, and an axial fan for cooling the tube, was used for an anode heat exchange unit 8; and likewise for a cathode heat exchange unit 9. The air flow of the axial fan was adjusted, so that the temperature of the cell stack would be maintained at 60° C.

A fuel cell system was produced as the foregoing. Note that the present Example was not provided with an exhaust gas filter 11 for detecting the amount of fuel components in exhaust gas.

### (h) Evaluations on Power Generating Characteristics and Exhaust Gas

By using the fuel cell system 1, power was generated in the following manner. The DOFC 101 was connected to an electronic load device; and by this device, the current generated was adjusted to a constant current of 150 mA/cm². The stoichiometric ratio of the air was 4, and that of the fuel was 1.5. The time for power generation was 60 minutes; and an average voltage and fuel efficiency for that time was obtained. Moreover, the concentration of the methanol discharged from the exhaust pipe 48 was measured. Note that the average voltage obtained was referred to as the voltage generated in the fuel cell system 1.

The amount of MCO for obtaining fuel efficiency (c.f., equation (4)) was obtained as follows. First, the concentration of a carbon dioxide flowing through the cathode discharge pipe 47 was measured with a hand-held CO₂ meter available from Vaisala Inc. Meanwhile, the flow rate of the gas flowing through the cathode discharge pipe 47 was measured with a soapfilm flowmeter. The carbon dioxide contained in the gas correlated to the amount of the methanol which reached the cathode 15 by methanol crossover (MCO). Thus, the total amount of the carbon dioxide flowing through the cathode discharge pipe 47 was obtained; and then the amount of MCO was obtained based on the above correlation. Moreover, the current measured by the electronic load device was used as the current generated used for obtaining fuel efficiency. Then, fuel efficiency was obtained based on the equation (4).

The concentration of the methanol released from the exhaust pipe 48 was measured, by disposing a detector tube at the outlet part of the exhaust pipe 48.

Table 1 shows the results obtained as the foregoing.

TABLE 1

| | | | Concentration |
|---|---|---|---|
| | Voltage | Fuel | of discharged |
| | generated | efficiency | methanol |
| | (V) | (%) | (ppm) |
| Ex. 1 | 0.45 | 83 | 50 |
| Comp. Ex. 1 | 0.44 | 82 | 3000 |
| Comp. Ex. 2 | 0.38 | 78 | 50 |
| Comp. Ex. 3 | 0.36 | 76 | 50 |

### Comparative Example 1

A fuel cell system of Comparative Example 1 was the same as the system of Example 1, except that the fuel pipe 41 was connected to the liquid collecting tank 3; and the high concentration fuel and the collected liquid were mixed in the liquid collecting tank 3. Moreover, the system of Comparative Example 1 was evaluated on power generating characteristics and exhaust gas, as with Example 1. The results are shown in Table 1.

### Comparative Example 2

A fuel cell system of Comparative Example 2 was the same as the system of Example 1, except that the fuel filter 6 was disposed between the liquid collecting tank 3 and the two-liquid-joining unit 44. Moreover, the system of Comparative Example 2 was evaluated on power generating characteristics and exhaust gas, as with Example 1. The results are shown in Table 1.

### Comparative Example 3

A fuel cell system of Comparative Example 3 was the same as the system of Example 1, except that the fuel filter 6 was omitted. Moreover, the system of Comparative Example 3 was evaluated on power generating characteristics and exhaust gas, as with Example 1. The results are shown in Table 1.

The following has become evident from the results shown in Table 1. First, in the fuel cell system of Example 1, the concentration of the discharged methanol is significantly lower than that in the fuel cell system of Comparative Example 1. In the system of Example 1, the concentration of the discharged methanol can be made lower, by disposing the exhaust gas filter 11 at the exhaust pipe 48. Thus, safety of the system is remarkably high, even when the system is used indoors. Moreover, since the methanol concentration in exhaust gas is low, it is not necessary to use a costly and large-volume gas filter which excels in removing methanol.

Secondly, in the fuel cell system of Example 1, voltage generated and fuel efficiency improve more remarkably than those in the fuel cell systems of Comparative Examples 2 and 3. The reason for the above is as follows. That is, in Comparative Examples 2 and 3, the fuel and the collected liquid cannot be sufficiently mixed, and the diluted fuel with a non-uniform fuel concentration is supplied to the anode 14. Therefore, in Comparative Examples 2 and 3, there are occurrences of local increase in the amount of MCO, or increase in diffusion overvoltage due to local deficiency of the fuel; and as a result, power generating performance is poor. In contrast, in the fuel cell system of Example 1, the fuel filter 6 promotes mixing of water and fuel in the diluted fuel; and as a result, the diluted fuel with uniform fuel concentration is supplied to the anode 14. Thus, local MCO and local deficiency of the fuel do not easily occur; and as a result, power generating performance improves.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The fuel cell system of the present invention is useful as the power source for small mobile electronic devices such as laptop computers, cellular phones, and personal digital assistants (PDAs); and is furthermore useful as a portable power generator.

### EXPLANATION OF REFERENCE NUMERALS

1 fuel cell system
2 fuel tank
3 liquid collecting tank
4 first fuel supply unit
5 second fuel supply unit
6 fuel filter
7 oxidant supply unit
13 electrolyte membrane
14 anode
15 cathode
101 direct oxidation fuel cell (DOFC)
102 fuel cell

1. A fuel cell system comprising:
a membrane electrode assembly including an anode, a cathode, and an electrolyte membrane interposed between the anode and the cathode;
a fuel tank which stores a liquid fuel;
a liquid collecting tank which stores a liquid discharged from at least one of the anode and the cathode, as a collected liquid;
a two-liquid-joining unit which prepares a diluted fuel by mixing the liquid fuel supplied from the fuel tank and the collected liquid supplied from the liquid collecting tank;
a first fuel supply unit which supplies the liquid fuel to the two-liquid-joining unit;
a second fuel supply unit which supplies the diluted fuel to the anode; and
a fuel filter which removes impurities in the diluted fuel, the filter disposed between the two-liquid-joining unit and the anode.

2. The fuel cell system in accordance with claim 1, wherein the fuel filter contains an ion exchange resin in the form of powder or granules.

3. The fuel cell system in accordance with claim 2, wherein the ion exchange resin is a cation exchange resin.

4. The fuel cell system in accordance with claim 1, wherein the diluted fuel has a fuel concentration equal to or lower than ½ of, and equal to or higher than 1/30 of a fuel concentration in the liquid fuel in the fuel tank.

5. The fuel cell system in accordance with claim 1, wherein the two-liquid-joining unit is a three-way pipe that is Y-shaped or T-shaped.

6. The fuel cell system in accordance with claim 1, wherein the second fuel supply unit is disposed between the two-liquid-joining unit and the anode.

7. The fuel cell in accordance with claim 1, wherein the liquid fuel contains at least one fuel selected from the group consisting of methanol, ethanol, formaldehyde, formic acid, dimethylether, ethylene glycol, and low molecular weight polymers thereof.
